(19) United States
(12) Patent Application Publication
(10) Pub. No.: US 2007/0268838 A1
(43) Pub. Date: Nov. 22, 2007

(54) System and Method For Facilitating An Internet Protocol Based Personal Area Network

(75) Inventor: Billy G. Moon, Cary, NC (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/383,592

(22) Filed: May 16, 2006

(51) Int. Cl. H04L 12/28; H04L 12/56

(52) U.S. Cl. 370/254; 370/401; 370/389

(57) ABSTRACT

A technique for facilitating an Internet Protocol (IP) based Personal Area Network (PAN) includes a personal communications device operable to initiate a discovery request to determine one or more available endpoints in a PAN. The personal communications device receives a discovery reply from one or more available endpoints in the PAN. A unique PAN address is assigned to each endpoint associated with a discovery reply. The personal communications device facilitates communication within the PAN, with another PAN, with a local area network, or with a wide area network for each endpoint assigned a unique PAN address.

### TECHNICAL FIELD OF THE INVENTION

This invention relates generally to the field of communications and more specifically to a system and method for facilitating an Internet Protocol based Personal Area Network.

### BACKGROUND

Users interact and communicate using various types of devices such as desktop computers, laptop computers, personal digital assistants, desktop phones, cell phones, and other devices. These user interactions and communications are typically accomplished in a fixed core network. However, a user may want to use a network without accessing a fixed core network where communications need only be made with other users. An example is a personal area network (PAN) closely associated with a human user where address and communications are managed on a smaller scale. The Bluetooth format is a classic example of a PAN in which a small network is established between personal devices. The deficiency in the Bluetooth format is that it does not allow for local/wide area network access. However, most PAN devices are not Internet Protocol centric. Conventionally, if traffic is to be transmitted from the PAN to other networks, a device within the PAN acts as a host and attempts to reach a fixed core network.

### SUMMARY OF THE DISCLOSURE

From the foregoing, it may be appreciated by those skilled in the art that a need has arisen for an improved technique for providing interaction between a PAN and other networks. In accordance with the present invention, a system and method for facilitating an Internet Protocol (IP) based PAN are provided that substantially eliminate or greatly reduce disadvantages and problems associated with conventional PAN techniques.

According to one embodiment of the present invention, a system and method for facilitating an IP-based PAN includes a personal communications device operable to initiate a discovery request to determine one or more available endpoints in a PAN. The personal communications device receives a discovery reply from one or more available endpoints in the PAN. A unique PAN address is assigned to each endpoint associated with a discovery reply. The personal communications device facilitates communication within the PAN, with another PAN, with a local area network, or with a wide area network for each endpoint assigned a unique PAN address.

Certain embodiments of the invention may provide one or more technical advantages. A technical advantage of an embodiment includes providing an IP-based PAN to facilitate communications over a suitable network. For example, a discovery protocol is used to facilitate communications within a smaller personal network without having to access a larger core network. Another advantage of another embodiment includes providing a protocol that supports traffic through various networks over the same physical media. For example, the protocol supports a PAN, a local area network (LAN), and/or a wide area network (WAN) traffic over the same physical media. Yet another technical advantage of an embodiment includes configuring PAN devices on a wireless network, where the network links may be used for PAN, LAN, and/or WAN traffic.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, wherein like reference numerals represent like parts, in which:

FIG. 1 illustrates an embodiment of a system that facilitates an IP-based PAN;

FIG. 2 is a flowchart illustrating an embodiment of a process for discovering endpoints in the IP-based PAN;

FIG. 3 is a flowchart illustrating an embodiment of a process for receiving a PAN address in the IP-based PAN.

### DETAILED DESCRIPTION OF THE DRAWINGS

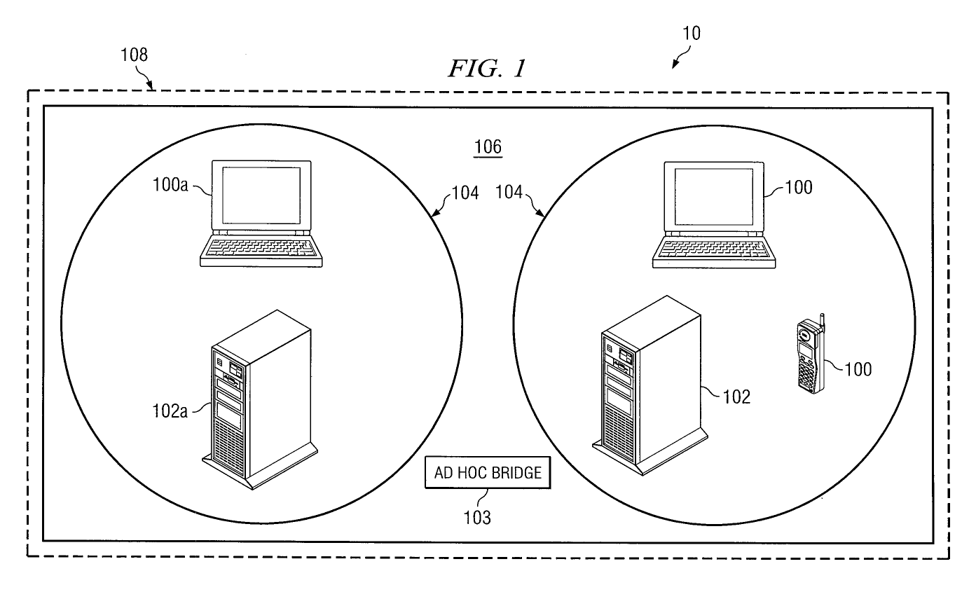

FIG. 1 illustrates an embodiment of a system 10 that facilitates an IP-based PAN 104. System 10 includes various network types, PAN 104, LAN 106, and WAN 108, and endpoints 100 within PAN 104. Personal communications device (PCD) 102 facilitates the communication of endpoints 100 within PAN 104. Using the IP-based PAN protocol, endpoints 100 within PAN 104 may communicate with LAN 106 and/or WAN 108 without accessing a fixed core network.

Endpoints 100 represent any suitable device operable to communicate using networks 104, 106, and/or 108. Endpoints 100 exchange audio, voice, data, video, or other information in system 10. To control the exchange of the information, endpoints 100 send signaling or any suitable control requests within system 10. Furthermore, the requests may be in any suitable communication protocol. Endpoints 100 may be any combination of hardware and/or software that provide communication services to a user. Endpoints 100 may include analog, digital, or Internet Protocol (IP) telephones, a cellular phone, a wireless fidelity (Wi-Fi) phone, a personal computer such as a laptop or a desktop, a personal computer running a telephony application, a personal digital assistant, a headset, or any other suitable device operable to communicate with system 10.

PCD 102 manages endpoints 100 within PAN 104 by performing any suitable function, such as providing network addresses for endpoints 100 to use or controlling which endpoints 100 join PAN 104. Each PCD 102 has an associated user. In an embodiment, PCD 102 establishes PAN 104 for endpoints 100 and allows endpoints 100 to communicate within PAN 104 and to other networks. For example, PCD 102 acts as the gateway to other networks. PCD 102 includes any suitable combination of hardware and/or software that routes traffic and facilitates communication within PAN 104 and with other networks using any suitable communication technology or protocol. In an embodiment, PCD 102 includes an 802.11 radio. For example, the 802.11 radio runs in an ad-hoc mode and provides a link to each of the other 802.11 radios within the other PCDs 102.

Networks 104, 106, and 108 allow elements within system 10 to communicate with each other. In the illustrated embodiment, network 104 represents a PAN 104, network 106 represents a LAN 106, and network 108 represents a WAN 108. Networks 104, 106, and 108 may include any other public or private data network, a local, regional, or global communication network such as the Internet, an enterprise intranet, other suitable wireline or wireless communication link, or any combination of the preceding. PAN 104, LAN 106, and WAN 108 may include any combination of gateways, routers, hubs, switches, access points, base stations, and any other hardware and/or software that may implement any suitable protocol or communication.

In an example embodiment of operation, a protocol for an IP-based PAN uses a discovery process from PCD 102 to allow endpoints 100 to access PAN 104. In the illustrated embodiment, an ad-hoc bridge 103 shares the same service set identifier (SSID) with PCDs 102. The ad-hoc bridge 103 provides access to LAN 106 and WAN 108 for PCD 102. Using an IP-based PAN protocol, PCD 102a discovers available endpoints 100 and provides endpoint 100a with a network address to use for communication. Endpoint 100a uses the network address for communication for a limited period of time.

In this example, a user has a PCD 102a and an endpoint 100a, which has an 802.11 ad-hoc radio with the same SSID as other PCDs 102 having an 802.11 ad-hoc radio. Therefore, all elements within system 10, the ad-hoc bridge 103, PCDs 102, and endpoints 100 can communicate with each other directly. The user activates endpoint 100a, and attempts to get a network address to use for communication. Dynamic Host Configuration Protocol (DHCP) does not provide an appropriate solution because if each PCD 102 has a DHCP server, it could not be determined which PCD 102 hands endpoint 100a an address without having some type of static configuration in PCDs 102. Static configuration of endpoint 100 is not an appropriate solution. PCD 102 implements a protocol to determine when an endpoint 100 needs communication capability and provides endpoint 100 with an appropriate address to facilitate communication within PAN 104, LAN 106, and WAN 108.

Modifications, additions, or omissions may be made to system 10. For example, system 10 may include any suitable number of endpoints 100, PCDs 102, or other components that provide for facilitating an IP-based PAN 104. As another example, system 10 may operate in any suitable version of IP, such as IP version 4 (IPv4) or IP version 6 (IPv6). The system and its operation may be altered accordingly to operate in the appropriate version. Furthermore, various security mechanisms may be added to the protocol to assure that endpoint 100 and PCD 102 are correctly associated with each other.

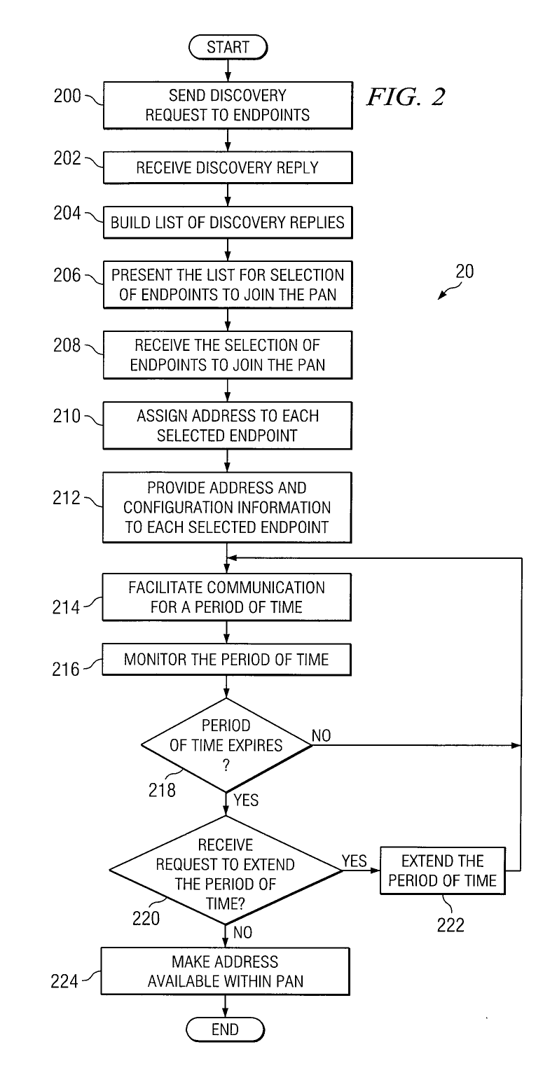

FIG. 2 is a flowchart illustrating an embodiment of a process performed by PCD 102 in discovering endpoints 100 in the IP-based PAN 104. In the IP protocol of PAN 104, a discovery process is used where a discovery request is initiated from the network side rather than the client side, i.e. endpoint 100. If endpoint 100 is acceptable to PCD 102, endpoint 100 receives configuration and address information either automatically or based on user selection. The method may be used by any suitable system, such as system 10 of FIG. 1.

The method begins at step 200 where PCD 102 sends a discovery request to endpoints 100. Rather than having endpoints 100 search for an available network, PCD 102 functioning as a gateway for PAN 104, searches for available endpoints 100 within PAN 104. The discovery request may include information related to the type of device that PCD 102 wishes to discover. For example, PCD 102 may wish to discover all available printers, all available laptops, all available laptops and PDAs, or all devices except printers. The source address of the discovery request is the source address owned by PCD 102. PCD 102 broadcasts the discovery request to endpoints 100.

Any suitable endpoint 100 may detect the discovery request and transmit a discovery reply. When a discovery request is received, endpoint 100 may compare the type of device identified in the discovery request to its type. If there is a match, endpoint 100 would send a discovery reply to PCD 102 if it is not already associated with another PCD 102. The discovery reply may be transmitted as a unicast User Datagram Protocol (UDP) message from the source link local address of endpoint 100 to the source address of the received discovery request. The source link local address for endpoint 100 is a temporary local address determined by endpoint 100 upon activation. The discovery reply may include information associated with endpoint 100 and its capabilities. At step 202, PCD 102 receives a discovery reply from each endpoint 100 that is available for communication within PAN 104.

In some situations, endpoint 100 may not send a discovery reply in response to a discovery request broadcasted by PCD 102. For example, if endpoint 100 is already communicating with PCD 102, LAN 106, or WAN 108, PCD 102 does not receive a discovery reply from endpoint 100. In another example, endpoint 100 may have previously provided a discovery reply and received a PAN address from PCD 102 that is still valid for use by endpoint 100. Other situations may also arise where it is not necessary for endpoint 100 to send a discovery reply upon being prompted by a discovery request from PCD 102.

In some situations, an endpoint 100 may elect to join more than one PAN 104. For example, a shared printer may respond to discovery requests from several PCDs 102 that specify a printer to be discovered. A shared endpoint 100 may send a discovery reply to each PCD 102 that broadcasts a discovery request. Shared endpoint 100 would then receive an address from each PCD 102 and have multiple homes in the various PANs 104. Upon receiving a number of addresses, each valid for a different PAN 104 with each PAN 104 having a unique gateway PCD 102, shared endpoint 100 would then be capable of communicating with devices in several different PANs 104. In the example provided, shared endpoint 100 would be able to provide print services for each PAN 104 to which it has established a home.

PCD 102 builds a list of discovery replies at step 204 and presents the list for selection at step 206. The list may be presented to a user interface for selection. A user selects from the list which endpoints 100 to join PAN 104. The user may select zero or any other endpoints 100 from the list to join PAN 104. PCD 102 receives the selection of endpoints 100 at step 208. PCD 102 assigns an available PAN address to each selected endpoint 100 at step 210. Alternatively, PCD 102 may assign an available PAN address to each endpoint 100 on the list without requiring user selection. The assigned PAN address is a valid available address within PAN 104 as determined by PCD 102. Assigned PAN addresses are unique at any given moment of time but may be re-assignable at later points in time. The PAN address becomes the source address for endpoint 100 to facilitate communications by endpoint 100 within PAN 104 and communications by endpoint 100 with LAN 106, WAN 108, and other PANs 104 through PCD 102. At step 212, PCD 102 provides the PAN address and configuration information to each selected endpoint 100. For example, PCD 102 provides Gateway and other Domain Name Server (DNS) information to the selected endpoints 100. PCD 102 may provide the PAN address and configuration information to selected endpoints 100 via a unicast User Datagram Protocol (UDP) message. The PAN address may be assigned to endpoints 100 to use for a period of time. For example, endpoints 100 may use the PAN address for any suitable configurable period of time. Endpoints 100 are not assigned a permanent network address as they do not have a permanent constant presence in any network. The amount of time a PAN address is assigned to an endpoint 100 is configurable and may be extended upon request from endpoint 100.

PCD 102 facilitates communications for endpoints 100 at step 214 within PAN 104 using the PAN address assigned by PCD 102. During communications, PCD 102 selects or routes the packet to another PCD 102, LAN 106, or WAN 108 via the ad-hoc bridge 103 or to another endpoint 100 within the same PAN 104. PCD 102 monitors the period of time endpoint 100 uses the PAN address at step 216 and determines at step 218 whether the period of time has expired. If the period of time has not expired, PCD 102 continues facilitating communications for endpoint 100. If the period of time has expired, PCD 102 determines whether endpoint 100 requests an extension of the period of time at step 220. When endpoint 100 requests an extension, PCD 102 extends the period of time at step 222 and continues facilitating communications for endpoint 100 using the assigned PAN address over the extended period of time. If PCD 102 does not receive a request to extend the period of time, PCD 102 makes the previously assigned PAN address available within PAN 104 at step 224. PCD 102 may also be configured to automatically extend the period of time if it determines that endpoint 100 is maintaining communications therewith.

Modifications, additions, or omissions may be made to flowchart 20. For example, PCD 102 may provide PAN addresses to all endpoints 100 that send discovery replies to PCD 102, rather than developing a list of endpoints 100 and using a process to assign PAN addresses to only selected endpoints 100 in the list. Communications between PCD 102 and endpoints 100 and with LAN 106, WAN 108, and other PANs 104 may be accomplished through any conventional communication protocol techniques. The method may include more, fewer, or other steps. Additionally, steps may be performed in any suitable order.

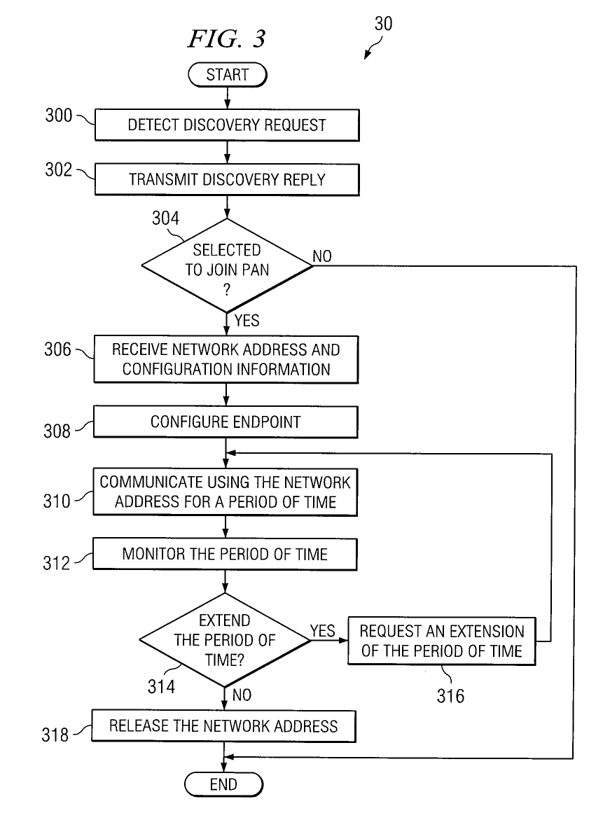

FIG. 3 is a flowchart illustrating an embodiment of a process performed by endpoint 100 in receiving a network address in the IP-based PAN. If endpoint 100 is acceptable to PCD 102, endpoint 100 receives configuration information from PCD 102. The method may be used by any suitable system, such as system 10 of FIG. 1.

The method begins at step 300 when endpoint 100 detects a discovery request. In an embodiment, endpoint 100 is in a discovery mode to detect the discovery request. While in the discovery mode, endpoint 100 temporarily configures its own network address as a non-conflicting local address. In another embodiment, endpoint 100 automatically goes into a discovery mode if it does not have an assigned PAN address. PCD 102 broadcasts a request to discover any endpoints 100 available for communication within PAN 104. Endpoint 100 detects the discovery request and, at step 302, transmits a discovery reply. The discovery reply may be transmitted via a unicast UDP message according to the temporary local address of endpoint 100 to the source address of the received discovery request. The discovery reply may include any suitable information such as various properties that are used to describe endpoint 100 and its capabilities. A determination is made at step 304 as to whether endpoint 100 has been selected to join PAN 104. If the user does not select endpoint 100, the method ends. If endpoint 100 is selected to join PAN 104, endpoint 100 receives its assigned PAN address and configuration information from PCD 102 at step 306. Endpoint 100 is configured with the configuration information at step 308. For example, upon receiving the assigned PAN address and configuration information, endpoint 100 automatically configures its radio interface with the new values. As another example, endpoint 100 stores the period of time it is assigned the PAN address.

Using the assigned PAN address and configuration information, endpoint 100 communicates within PAN 104 at step 310 using the assigned PAN address for a period of time. The packets will be sourced according to the assigned PAN address and forwarded to PCD 102, the default gateway. Endpoint 100 monitors the period of time allocated for the assigned PAN address at step 312. Endpoint 100 determines at step 314 whether to extend the period of time for the assigned PAN address. If endpoint 100 decides to extend the period of time, endpoint 100 requests an extension of the period of time for the assigned PAN address at step 316. If endpoint 100 decides not to extend the period of time, the assigned PAN address is released at step 318 for later re-assignment by PCD 102.

Modifications, additions, or omissions may be made to the method. For example, endpoint 100 may receive the PAN address and configuration information automatically through transmission of the discovery reply rather than receiving the PAN address and configuration information based on the user's selection. The method may include more, fewer, or other steps. Additionally, steps may be performed in any suitable order and by any suitable component in system 10.

While this disclosure has been described in terms of certain embodiments and generally associated methods, alterations and permutations of the embodiment and methods will be apparent to those skilled in the art. Accordingly, the above description of example embodiments does not constrain this disclosure. Other changes, substitutions, and alterations are also possible without departing from the scope and spirit of this disclosure.

What is claimed is:

1. A method for discovering one or more endpoints in an Internet Protocol (IP) based personal area network (PAN), comprising:
initiating a discovery request to determine one or more available endpoints in a PAN;
receiving a discovery reply from one or more available endpoints;
assigning a unique PAN address to each endpoint associated with a discovery reply;
facilitating communication within the PAN, with another PAN, with a local area network, or with a wide area network for each endpoint assigned a unique PAN address.

2. The method of claim 1, further comprising:
building a list of the received discovery replies;
presenting the list through a user interface for selection of endpoints to join the PAN.

3. The method of claim 2, further comprising:
receiving a selection of endpoints to join the PAN.

4. The method of claim 1, further comprising:
providing a unique PAN address to each endpoint associated with a discovery reply;
providing configuration information to each endpoint associated with a discovery reply.

5. The method of claim 1, wherein a unique PAN address is available for use for a limited period of time.

6. The method of claim 5, further comprising:
monitoring the limited period of time a unique PAN address is available for use.

7. The method of claim 6, further comprising:
receiving an extension request from an endpoint to extend the limited period of time associated with its unique PAN address.

8. The method of claim 7, further comprising:
extending the limited period of time of available use for the endpoint's unique PAN address in response to the extension request.

9. The method of claim 5, further comprising:
releasing a unique PAN address upon expiration of its limited period of time of available use.

10. The method of claim 9, further comprising:
re-assigning a unique PAN address upon expiration of its limited period of time of available use.

11. A system for discovering one or more endpoints in an Internet Protocol (IP) based personal area network (PAN), comprising:
means for initiating a discovery request to determine one or more available endpoints in a PAN;
means for receiving a discovery reply from one or more available endpoints;
means for assigning a unique PAN address to each endpoint associated with a discovery reply;
means for facilitating communication within the PAN, with another PAN, with a local area network, or with a wide area network for each endpoint assigned a unique PAN address.

12. The system of claim 11, further comprising:
means for providing a unique PAN address to each endpoint associated with a discovery reply;
means for providing configuration information to each endpoint associated with a discovery reply.

13. The system of claim 11, wherein a unique PAN address is available for use for a limited period of time.

14. The system of claim 13, further comprising:
means for extending the limited period of time of available use for the endpoint's unique PAN address in response to the extension request.

15. The system of claim 13, further comprising:
means for re-assigning a unique PAN address upon expiration of its limited period of time of available use.

16. A system for discovering one or more endpoints in an Internet Protocol (IP) based personal area network (PAN), comprising:
a personal communications device operable to initiate a discovery request to determine one or more available endpoints in a PAN, the personal communications device operable to receive a discovery reply from one or more available endpoints, the personal communications device operable to assign a unique PAN address to each endpoint associated with a discovery reply, the personal communications device operable to facilitate communication within the PAN, with another PAN, with a local area network, or with a wide area network for each endpoint assigned a unique PAN address.

17. The system of claim 16, wherein the personal communications device is operable to provide a unique PAN address to each endpoint associated with a discovery reply, the personal communications device operable to provide configuration information to each endpoint associated with a discovery reply.

18. The system of claim 16, wherein a unique PAN address is available for use for a limited period of time.

19. The system of claim 18, wherein the personal communications device is operable to extend the limited period of time of available use for the endpoint's unique PAN address in response to the extension request.

20. The system of claim 18, wherein the personal communications device is operable to re-assign a unique PAN address upon expiration of its limited period of time of available use.

21. A computer readable medium including code for discovering one or more endpoints in an Internet Protocol (IP) based personal area network (PAN), the code operable to:
initiate a discovery request to determine one or more available endpoints in a PAN;
receive a discovery reply from one or more available endpoints;
assign a unique PAN address to each endpoint associated with a discovery reply;
facilitate communication within the PAN, with another PAN, with a local area network, or with a wide area network for each endpoint assigned a unique PAN address.

22. The computer readable medium of claim 21, wherein the code is further operable to:
provide a unique PAN address to each endpoint associated with a discovery reply;
provide configuration information to each endpoint associated with a discovery reply.

23. The computer readable medium of claim 21, wherein a unique PAN address is available for use for a limited period of time.

24. The computer readable medium of claim 13, wherein the code is further operable to:
extend the limited period of time of available use for the endpoint's unique PAN address in response to the extension request.

25. The computer readable medium of claim 23, wherein the code is further operable to:
re-assign a unique PAN address upon expiration of its limited period of time of available use.
